(19) United States
(12) Patent Application Publication
(10) Pub. No.: US 2026/0058466 A1
(43) Pub. Date: Feb. 26, 2026

(54) METHOD AND SYSTEM FOR TRACKING DEFECTS IN KEY NODES OF MICROGRID

(71) Applicant: Xiamen Mintou Technology Service Co., Ltd., Xiamen (CN)

(72) Inventors: Wenbin LIN, Xiamen (CN); Zhouyang CAI, Xiamen (CN); Boyi FU, Xiamen (CN); Jiawei HE, Xiamen (CN); Baohuang ZHAN, Xiamen (CN); Xujie LIU, Xiamen (CN)

(73) Assignee: Xiamen Mintou Technology Service Co., Ltd., Xiamen (CN)

(21) Appl. No.: 19/305,729

(22) Filed: Aug. 20, 2025

(30) Foreign Application Priority Data
Aug. 20, 2024 (CN) 202411139646.8

(51) Int. Cl. H02J 3/00; H02J 3/38

(52) U.S. Cl. CPC H02J 3/0012; H02J 3/004; H02J 3/381; H02J 2203/20; H02J 2300/28

(57) ABSTRACT

The present application relates to the technical field of microgrid operation, and in particular, to a method and system for tracking defects in key nodes of a microgrid. The method includes: obtaining and analyzing real-time data of the microgrid to obtain power generation data of each distributed wind turbine in the microgrid, and analyzing the power generation data to predict a total generating power within a preset time; obtaining an operating power required for stable operation of the microgrid based on analysis results of the real-time data; determining a total charging power for energy storage devices based on the operating power and total generating power; obtaining an operating status, a usage frequency, and a distribution status of each energy storage device, and determining a charging power that should be allocated to each energy storage device based on the total charging power, operating status, usage frequency, and distribution status.

### CROSS-REFERENCE TO RELATED APPLICATIONS

The application claims priority to Chinese patent application No. 202411139646.8, filed on Aug. 20, 2024, the entire contents of which are incorporated herein by reference.

### TECHNICAL FIELD

The present application relates to the technical field of microgrid operation, and in particular, to a method and system for tracking defects in key nodes of a microgrid.

### BACKGROUND

Energy storage devices within a microgrid in the prior art effectively solve the problem of power fluctuation caused by the access of distributed power supplies by shaving peaks, filling valleys, stabilizing voltage and frequency, improving energy utilization efficiency, implementing multi-energy complementarity, and the like.

However, a large number of distributed wind turbines access the microgrid, and electric energy generated by them fluctuates significantly due to the influence of environmental factors. Such fluctuation incurs excessive load on the energy storage devices within the microgrid, so that their energy storage efficiency is significantly reduced, and even the energy storage devices are damaged in severe cases.

### SUMMARY

The present application provides a method and system for tracking defects in key nodes of a microgrid to solve the above technical problems.

In a first aspect, the present application provides a method for tracking defects in key nodes of a microgrid, including:
obtaining real-time data of the microgrid, analyzing the real-time data to obtain power generation data of each distributed wind turbine in the microgrid, and analyzing the power generation data to predict a total generating power within a preset time;
obtaining an operating power required for stable operation of the microgrid based on analysis results of the real-time data;
determining a total charging power for energy storage devices based on the operating power and the total generating power; and
obtaining an operating status, a usage frequency, and a distribution status of each energy storage device, and determining a charging power that should be allocated to each energy storage device based on the total charging power, the operating status, the usage frequency, and the distribution status; and designating the charging power that should be allocated to each energy storage device as a charging allocation strategy.

In this way, the determination of the charging allocation strategy can refine power management, help optimize energy allocation of the microgrid, reduce energy waste, and improve the operating efficiency of the microgrid. By obtaining and analyzing the operating status of each energy storage device, the charging power that should be allocated to each energy storage device can be intelligently determined based on the actual situation of the energy storage device and the total charging power, thereby prolonging the service lives of the energy storage devices, improving the charging efficiency, and helping grid operators make timely adjustments and decisions to ensure the stable operation of the microgrid.

Optionally, obtaining an operating power required for stable operation of the microgrid based on the real-time data includes:
obtaining a load power and a loss power of the microgrid based on the analysis results of the real-time data;
obtaining a usage power of the microgrid based on the load power and the loss power of the microgrid;
obtaining uncertainty factors in the microgrid, and determining a safety margin power required for the stable operation of the microgrid based on the uncertainty factors; and
obtaining the operating power required to maintain the stable operation of the microgrid based on the usage power and the safety margin power.

In this way, the real-time monitoring and analysis on the load power and the loss power can provide a more precise understanding of load conditions that the energy storage devices may encounter. By obtaining and analyzing the uncertain factors in the microgrid and determining the safety margin power required for the stable operation of the microgrid accordingly, an impact caused by uncertainties such as wind power fluctuations can be dealt more effectively. By combining the usage power and the safety margin power to determine the operating power required to maintain the stable operation of the microgrid, optimal utilization of energy is achieved, and energy waste is avoided.

Optionally, obtaining the operating power required to maintain the stable operation of the microgrid based on the usage power and the safety margin power refers to the following formula:

$${P}_{required} = {P}_{load} + {P}_{loss} + {P}_{safety} ;$$

where P_{required} represents the operating power required to maintain the stable operation of the microgrid; P_{load} represents the load power of the microgrid; Pₗₒₛₛ represents the loss power in the microgrid; and P_{safety} represents the safety margin power of the microgrid.

In this way, the formula is designed to precisely compute the total power required to maintain the stable operation of the microgrid. The load power, the loss power, and the safety margin power in the usage power are added to obtain a comprehensive power demand value. This value reflects the total power required by the microgrid during normal operation and in dealing with potential risks and uncertainties.

Optionally, determining a safety margin power required for the stable operation of the microgrid based on the uncertainty factors includes:
determining a corresponding fluctuating power based on the uncertainty factors, with reference to the following formula:

$$Δ {P}_{gen} = N ( {μ}_{gen} , {σ}_{gen}^{2} ) ;$$

where ΔP_{gen} represents the fluctuating power induced by uncertainty; μ_{gen} represents a mean value of load fluctuating powers; σ_{gen} represents a standard deviation of the load fluctuating powers; and N(μ_{gen}, σ²_{gen}), represents a standard deviation function;
determining the safety margin power based on the fluctuating power, with reference to the following formula:

$${P}_{safety} = Δ {P}_{gen , max} = {μ}_{gen} + {z}_{gen} \cdot {σ}_{gen} ;$$

where P_{safety} represents the safety margin power; ΔP_{gen,max} represents a maximum fluctuating power induced by uncertainty; μ_{gen} represents the mean value of the fluctuating powers; z_{gen} represents a corresponding quantile at a confidence level; and σ_{gen} represents the standard deviation of the fluctuating powers.

In this way, the formula is designed to obtain a reasonable safety margin power, which can help prevent problems such as power supply interruption or device damage in face of uncertainties induced by the access of renewable energy sources such as distributed wind turbines, thereby ensuring stable operation.

Optionally, determining a total charging power for energy storage devices based on the operating power and the total generating power refers to the following formula:

$${P}_{total} = {\sum }_{i = 1}^{n} {P}_{wind , i} - {P}_{required} ;$$

where Pₜₒₜₐₗ represents the total charging power; P_{wind,i} represents a generating power of the i^{th} distributed wind turbine; n represents a quantity of the distributed wind turbines in the microgrid; and P_{required} represents the operating power required to maintain the stable operation of the microgrid.

In this way, the formula is designed to obtain the total charging power, ensuring that excess energy can be absorbed by the energy storage devices when the wind generating power exceeds the operating power, thereby avoiding energy waste and device overload.

Optionally, determining a charging power that should be allocated to each energy storage device based on the total charging power, the operating status, the usage frequency, and the distribution status includes:
analyzing the operating status to obtain a current electric quantity and power load of the energy storage device;
analyzing the distribution status to obtain a transmission distance between the energy storage device and the microgrid;
obtaining a line loss based on the transmission distance; and
determining the charging power that should be allocated to each energy storage device based on the current electric quantity and power load, the usage frequency, and the line loss, with reference to the following formula:

$${P}_{i} = {P}_{total} \cdot \frac{\frac{{f}_{i} \cdot {s}_{i}}{1 + l ( {d}_{i} )}}{{\sum }_{j = 1}^{n} \frac{{f}_{j} \cdot {s}_{j}}{1 + l ( {d}_{j} )}} ;$$

where Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;
obtaining a line loss based on the transmission distance refers to the following formula:

$$l ( {d}_{i} ) = ( \frac{{P}_{total}}{{d}_{i}^{2}} ) \cdot ( 1 - \frac{{l}_{i}^{2} \cdot {ρ}_{i} \cdot \frac{{d}_{i}}{{A}_{i}}}{{P}_{total}} ) \cdot {η}_{i} ;$$

where l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Aᵢ represents a cross-sectional area of the transmission line for the i^{th} energy storage device; and ηᵢ represents a conversion efficiency of the i^{th} energy storage device;
obtaining a maximum energy storage capacity of the energy storage device based on the current electric quantity;
where the power load does not exceed a maximum power limit, with reference to the following formula:

$$0 \leq {P}_{i} \leq {P}_{max , i} , ∀ i ;$$

where Pᵢ represents the charging power for the i^{th} energy storage device; and P_{max,i} represents a maximum charging power for the i^{th} energy storage device.

In this way, the current electric quantity and power load of the energy storage device are obtained by monitoring its operating status. The formula is designed to compute the total charging power, thereby ensuring the operation of devices within a safe range, preventing overloading of the devices, prolonging the service lives of the devices, reducing the risk of failure, avoiding overcharging, maintaining the healthy status of the energy storage devices and prolonging their service life, and ensuring that the power load of each energy storage device does not exceed its maximum power limit.

Optionally, determining a charging power that should be allocated to each energy storage device based on the total charging power, the operating status, the usage frequency, and the distribution status further includes:
performing load balancing based on the power load of each energy storage device, with reference to the following formula:

$${L}_{i} = \frac{{P}_{i}}{{P}_{max , i}} ;$$

where Lᵢ represents an i^{th} load factor; Pᵢ represents the charging power for the i^{th} energy storage device; and P_{max,i} represents the maximum charging power for the i^{th} energy storage device;
where the load factor Lᵢ is an indicator used to quantify a ratio of the current charging power for each energy storage device to the maximum charging power therefor;
obtaining a final load factor during the load balancing based on the load factors of all the energy storage devices; and
obtaining the charging power for each energy storage device during the load balancing based on the final load factor.

In this way, the load balancing can ensure that each energy storage device is effectively utilized, thereby improving the charging efficiency of an overall system, avoiding accelerated aging or damage of some devices due to overload, and thus prolonging the service lives of the energy storage devices. When all the energy storage devices operate at similar load levels, the overall stability of the system will be enhanced. The load balancing facilitates more reasonable allocation of the charging power among the energy storage devices, thereby ensuring efficient utilization of energy.

Optionally, obtaining a final load factor during the load balancing based on the load factors of all the energy storage devices refers to the following formula:

$$L = min {\sum }_{i = 1}^{n} {( {L}_{i} - \overline{L} )}^{2} ;$$

where L represents the final load factor during the load balancing; Lᵢ represents the load factor of the i^{th} energy storage device; and L̅ represents a mean value of the load factors of all the energy storage devices; and
designating the Lᵢ satisfying L as the final load factor during the load balancing.

In this way, the charging power for each energy storage device is adjusted to make their load factors as close as possible, thereby avoiding the situation where some energy storage devices are overloaded while others are lightly loaded. When all the devices operate at similar load levels, the charging efficiency of the overall system is improved, the energy storage devices operate in an inefficient status to avoid overload, the service lives of the energy storage devices can be effectively prolonged, and damage to the energy storage devices can be avoided, thereby improving the stability of the overall system.

Optionally, analyzing the power generation data to predict a total generating power within a preset time includes:
extracting keywords from historical power generation data in the microgrid to obtain simple data;
cleaning the simple data to obtain cleaned data;
normalizing the cleaned data to obtain computable data;
training a model associated between the generating power and meteorological factors based on the computable data; and
inputting real-time meteorological data into the trained model to obtain the total generating power within the preset time.

In this way, by training the linear regression model to learn historical data, the linear regression model learns how to predict a generating power based on these meteorological factors, thereby more accurately predicting a future generating power. Accurate predictions can formulate and adjust the charging allocation strategy for the energy storage devices. Through prediction, unnecessary investment in backup power supplies can be reduced, and operating costs can be lowered.

In a second aspect, the present application provides a system for tracking defects in key nodes of a microgrid, including:
a power prediction module, configured to obtain real-time data of the microgrid, analyze the real-time data to obtain power generation data of each distributed wind turbine in the microgrid, and analyze the power generation data to predict a total generating power within a preset time;
a demand analysis module, configured to obtain an operating power required for stable operation of the microgrid based on the real-time data;
a total charging power statistics module, configured to determine a total charging power for energy storage devices based on the operating power and the total generating power; and
an energy storage device power allocation module, configured to obtain an operating status, a usage frequency, and a distribution status of each energy storage device, and determine a charging power that should be allocated to each energy storage device based on the total charging power, the operating status, the usage frequency, and the distribution status; and designate the charging power that should be allocated to each energy storage device as a charging allocation strategy.

Optionally, the demand analysis module is specifically configured to:
obtain a load power and a loss power of the microgrid based on the analysis results of the real-time data;
obtain a usage power of the microgrid based on the load power and the loss power of the microgrid;
obtain uncertainty factors in the microgrid, and determine a safety margin power required for the stable operation of the microgrid based on the uncertainty factors; and
obtain the operating power required to maintain the stable operation of the microgrid based on the usage power and the safety margin power.

Optionally, the demand analysis module is specifically configured to:
obtain the operating power required to maintain the stable operation of the microgrid based on the usage power and the safety margin power, with reference to the following formula:

$${P}_{required} = {P}_{load} + {P}_{loss} + {P}_{safety} ;$$

where P_{required} represents the operating power required to maintain the stable operation of the microgrid; P_{load} represents the load power of the microgrid; Pₗₒₛₛ represents the loss power in the microgrid; and P_{safety} represents the safety margin power of the microgrid.

Optionally, the demand analysis module is specifically configured to:
determine the safety margin power required for the stable operation of the microgrid based on the uncertainty factors, including:
determining a corresponding fluctuating power based on the uncertain factors, with reference to the following formula (2):

$$Δ {P}_{gen} = N ( {μ}_{gen} , {σ}_{gen}^{2} ) \qquad ( 2 )$$

where ΔP_{gen} represents the fluctuating power induced by uncertainty; μ_{gen} represents a mean value of load fluctuating powers; σ_{gen} represents a standard deviation of the load fluctuating powers; and N(μgₑₙ,σ²_{gen}) represents a standard deviation function;
determining the safety margin power based on the fluctuating power, with reference to the following formula (3):

$${P}_{safety} = Δ {P}_{gen , max} = {μ}_{gen} + {z}_{gen} \cdot {σ}_{gen} \qquad ( 3 )$$

where P_{safety} represents the safety margin power; ΔP_{gen,max} represents a maximum fluctuating power induced by uncertainty; μ_{gen} represents the mean value of the fluctuating powers; z_{gen} represents a corresponding quantile at a confidence level; and σ_{gen} represents the standard deviation of the fluctuating powers.

Optionally, the total charging power statistics module is specifically configured to:
determine the total charging power for the energy storage devices based on the operating power and the total generating power, with reference to the following formula:

$${P}_{total} = {\sum }_{i = 1}^{n} {P}_{wind , i} - {P}_{required} ;$$

where Pₜₒₜₐₗ represents the total charging power; P_{wind,i} represents a generating power of the i^{th} distributed wind turbine; n represents a quantity of the distributed wind turbines in the microgrid; and P_{required} represents the operating power required to maintain the stable operation of the microgrid.

Optionally, the total charging power statistics module is specifically configured to:
analyze the operating status to obtain a current electric quantity and power load of the energy storage device;
analyze the distribution status to obtain a transmission distance between the energy storage device and the microgrid;
obtain a line loss based on the transmission distance; and
determine the charging power that should be allocated to each energy storage device based on the current electric quantity and power load, the usage frequency, and the line loss, with reference to the following formula:

$${P}_{i} = {P}_{total} \cdot \frac{\frac{{f}_{i} \cdot {s}_{i}}{1 + l ( {d}_{i} )}}{{\sum }_{j = 1}^{n} \frac{{f}_{j} \cdot {s}_{j}}{1 + l ( {d}_{j} )}} ;$$

where Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;
obtaining a line loss based on the transmission distance refers to the following formula:

$$l ( {d}_{i} ) = ( \frac{{P}_{total}}{{d}_{i}^{2}} ) \cdot ( 1 - \frac{{I}_{i}^{2} \cdot {ρ}_{i} \cdot \frac{{d}_{i}}{{A}_{i}}}{{P}_{total}} ) \cdot {η}_{i} ;$$

where l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Aᵢ represents a cross-sectional area of the transmission line for the i^{th} energy storage device; and ηᵢ represents a conversion efficiency of the i^{th} energy storage device;
where the power load does not exceed a maximum power limit, with reference to the following formula:

$$0 \leq {P}_{i} \leq {P}_{max , i} , ∀ i ;$$

where Pᵢ represents the charging power for the i^{th} energy storage device; and P_{max,i} represents a maximum charging power for the i^{th} energy storage device.

Optionally, the energy storage device power allocation module is specifically configured to:
perform load balancing based on the power load of each energy storage device, with reference to the following formula:

$${L}_{i} = \frac{{P}_{i}}{{P}_{max , i}} ;$$

where Lᵢ represents an i^{th} load factor; Pᵢ represents the charging power for the i^{th} energy storage device; and P_{max,i} represents the maximum charging power for the i^{th} energy storage device;
where the load factor Lᵢ is an indicator used to quantify a ratio of the current charging power for each energy storage device to the maximum charging power therefor;
obtain a load factor during the load balancing based on the load factors of all the energy storage devices; and
obtain the charging power for each energy storage device during the load balancing based on the load factor.

Optionally, the energy storage device power allocation module is specifically configured to:
obtain the load factor during the load balancing based on the load factors of all the energy storage devices, with reference to the following formula:

$$L = min {\sum }_{i = 1}^{n} {( {L}_{i} - \overline{L} )}^{2} ;$$

where L represents the final load factor during the load balancing; Lᵢ represents the load factor of the i^{th} energy storage device; and L̅ represents a mean value of the load factors of all the energy storage devices.

Optionally, the feature extraction module is specifically configured to:
extract keywords from historical power generation data in the microgrid to obtain simple data;
clean the simple data to obtain cleaned data;
normalize the cleaned data to obtain computable data;
train a model associated between the generating power and meteorological factors based on the computable data; and
input real-time meteorological data into the trained model to obtain the total generating power within the preset time.

### BRIEF DESCRIPTION OF DRAWINGS

To more clearly illustrate the technical solutions in the embodiments of the present application or in the prior art, the accompanying drawings required in the description of the embodiments or the prior art will be briefly introduced below. Apparently, the accompanying drawings described below show some embodiments of the present application. A person of ordinary skill in the art can derive other drawings based on these drawings without any creative efforts.

FIG. 1 is a schematic diagram of an application scenario according to an embodiment of the present application;

FIG. 2 is a flowchart of a method for tracking defects in key nodes of a microgrid according to an embodiment of the present application; and

FIG. 3 is a schematic structural diagram of a system for tracking defects in key nodes of a microgrid according to an embodiment of the present application.

### DETAILED DESCRIPTION OF THE EMBODIMENTS

To make the objectives, technical solutions, and advantages of the embodiments of the present application clearer, the technical solutions in the embodiments of the present application will be described clearly and completely in conjunction with the accompanying drawings therein. Apparently, the described embodiments are some of the embodiments of the present application, not all of them. All other embodiments obtained by those of ordinary skill in the art based on the embodiments of the present application without any creative efforts fall within the scope of protection of the present application.

In addition, the term “and/or” herein merely describes a relationship between associated objects, indicating that there may be three relationships. For example, A and/or B may represent the following three cases: only A exists, both A and B exist, and only B exists. The character “/” herein, unless otherwise specified, generally indicates that the successive associated objects are in an “or” relationship.

The following is a further detailed description of the embodiments of the present application in conjunction with the accompanying drawings.

A large number of distributed wind turbines access a microgrid, and electric energy generated by them fluctuates significantly due to the influence of environmental factors. Such fluctuation incurs excessive load on the energy storage devices within the microgrid, so that their energy storage efficiency is significantly reduced, and even the energy storage devices are damaged in severe cases.

On this basis, the present application provides a method and system for tracking defects in key nodes of a microgrid. Based on real-time data of the microgrid, power generation data of each distributed wind turbine in the microgrid is analyzed to predict a total generating power within a preset time, then an operating power required for stable operation of the microgrid is obtained, and the operating power and the total generating power are detected in real time to determine a total charging power for energy storage devices; an operating status, a usage frequency, and a distribution status of each energy storage device are analyzed, and a charging power that should be allocated to each energy storage device is determined based on the total charging power, the operating status, the usage frequency, and the distribution status; and the charging power allocated to each energy storage device is designated as a charging allocation strategy. By obtaining the real-time data of the microgrid, a current operating status of the microgrid can be accurately grasped, the total generating power within the preset time can be predicted, and the total charging power for the energy storage devices can be further determined based on the operating power required for the stable operation of the microgrid. Such refined power management helps optimize energy allocation of the microgrid, reduces energy waste, and improves operating efficiency of the microgrid. By obtaining and analyzing the operating status, usage frequency, and distribution status of each energy storage device, the charging power that should be allocated to each energy storage device can be intelligently determined based on the actual situation of the device and the total charging power demand, thereby prolonging service lives of the energy storage devices, improving charging efficiency, and helping microgrid operators make timely adjustments and decisions to ensure the stable operation of the grid.

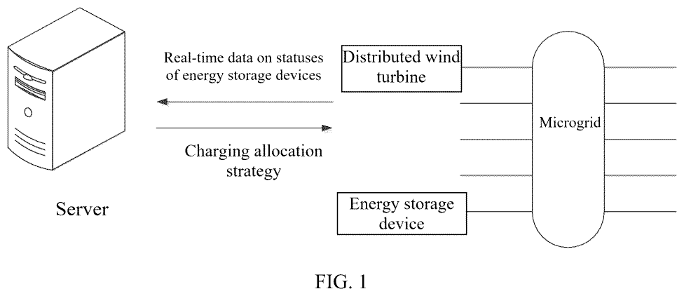

FIG. 1 is a schematic diagram of an application scenario provided by the present application. A large number of distributed wind turbines access a microgrid, and electric energy generated by them fluctuates significantly due to the influence of environmental factors. The method provided by the present application is used to analyze real-time data of distributed wind turbines and energy storage devices within the microgrid, so as to solve the problem of significant fluctuation of electric energy generated by the wind turbines due to the influence of environmental factors.

Specifically, the method of the present application is applied to any server, where the server interacts with the microgrid, and the microgrid includes distributed wind turbines and energy storage devices. The server obtains real-time data of the microgrid, analyzes the real-time data to predict a total generating power within a preset time and obtain an operating power required for stable operation of the microgrid, determines a total charging power for the energy storage devices, obtains an operating status, a usage frequency and a distribution status of each energy storage device, determines a charging power that should be allocated to each energy storage device, and designates the charging power that should be allocated to each energy storage device as a charging allocation strategy, thereby effectively maintaining the stability of grid power, avoiding excessive load on a single energy storage device, reducing the risk of damage to the energy storage devices, prolonging service lives of the energy storage devices, and improving overall energy storage efficiency of the energy storage devices.

A specific implementation may be referred to the following embodiment.

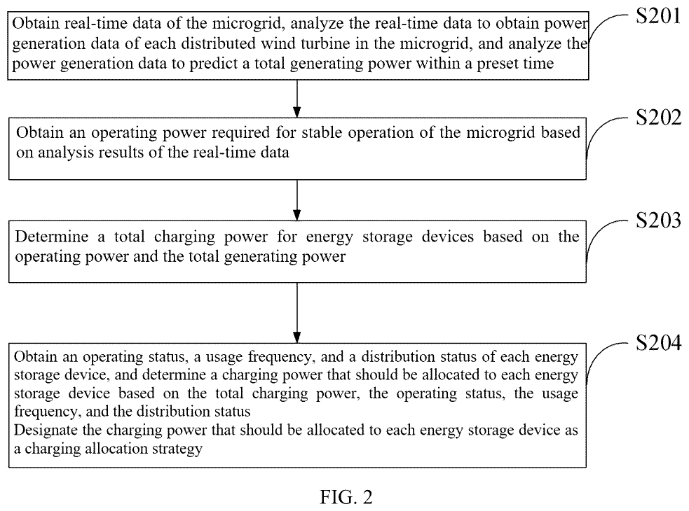

FIG. 2 is a flowchart of a method for tracking defects in key nodes of a microgrid according to an embodiment of the present application. The method of this embodiment may be applied to the server in the above scenario. As shown in FIG. 2, the method includes:

S201. Obtain real-time data of the microgrid, analyze the real-time data to obtain power generation data of each distributed wind turbine in the microgrid, and analyze the power generation data to predict a total generating power within a preset time.

The real-time data may include a load power, a loss power, and a safety margin power of the microgrid and power generation data of the distributed wind turbines.

The power generation data may be a generating power of each distributed wind turbine.

The preset time may be a future day or a period of time for future weather changes, such as duration of strong wind.

The total generating power may be a sum of the generating powers of the distributed wind turbines.

Specifically, the real-time data generated by the microgrid is collected in real time by using sensors, smart meters, or other data collection devices. The real-time data is transmitted to the server via a wireless network, and the data is stored in a database system. The collected real-time data is pre-processed, the pre-processed data is analyzed by using a data analysis tool to extract key indicators and obtain the power generation data of each distributed wind turbine, such as the generating power of each wind turbine, and the power generation data is analyzed by using a pre-trained prediction model, thereby predicting the total generating power within the preset time.

In specific implementation, a linear regression model may be selected as the pre-trained prediction model. Power generation data of each distributed wind turbine within a historical period and a total generating power in the corresponding historical period are used as training samples to train the linear regression model, enabling the trained prediction model to predict the total generating power within the preset time based on the inputted power generation data of each distributed wind turbine.

S202. Obtain an operating power required for stable operation of the microgrid based on analysis results of the real-time data.

The operating power required for the stable operation of the microgrid may be a fluctuating power caused by uncertain factors during the operation of the microgrid, including a usage power.

Specifically, on the basis of obtaining the real-time data of the microgrid, the real-time data is processed and analyzed by using a data analysis tool to extract key operating indicators such as the current load power, loss power, and safety margin power of the microgrid. According to grid standards and safety margin requirements, basic conditions, generally including the stability of power and the like, for the stable operation of the microgrid are analyzed to determine the power required for the stable operation of the microgrid.

S203. Determine a total charging power for energy storage devices based on the operating power and the total generating power.

The total charging power may be a sum of energy storage power demands of all the energy storage devices within the microgrid.

Specifically, if the predicted total generating power of the distributed wind turbines is greater than the operating power required for the stable operation of the microgrid, it indicates that additional electric energy is available for storage, and after the stable operation of the microgrid is satisfied, the remaining generating power may be used as the total charging power to charge the energy storage devices. At this point, a charging instruction is sent to the energy storage devices to start the energy storage devices for charging.

S204. Obtain an operating status, a usage frequency, and a distribution status of each energy storage device, and determine a charging power that should be allocated to each energy storage device based on the total charging power, the operating status, the usage frequency, and the distribution status; and designate the charging power that should be allocated to each energy storage device as a charging allocation strategy.

The operating status of the energy storage device may be the power level, temperature, health status, charging rate, maximum charging power, and the like of the energy storage device.

Specifically, current operating status information of all the energy storage devices is collected, and the collected operating statuses of the energy storage devices are analyzed to evaluate the charging capacity and limitation of each energy storage device, such as: some devices may not require charging due to being fully or nearly fully charged, while others may have a lower power level and need a large amount of charging power for charging. Based on the operating statuses of the energy storage devices and the stable operation requirements of the microgrid, an allocation principle for the charging power is formulated and combined with the total charging power and the operating statuses of the energy storage devices to compute the charging power that should be allocated to each energy storage device. This requires considering the maximum charging power limit of the energy storage device to avoid overload. The computed charging power that should be allocated to each device is organized into the charging allocation strategy.

The determination of the charging allocation strategy in this embodiment can refine power management, help optimize energy allocation of the microgrid, reduce energy waste, and improve the operating efficiency of the microgrid. By obtaining and analyzing the operating status, usage frequency, and distribution status of each energy storage device, the charging power that should be allocated to each energy storage device can be intelligently determined based on the actual situation of the energy storage device and the total charging power, thereby prolonging the service lives of the energy storage devices, improving the charging efficiency, and helping grid operators make timely adjustments and decisions to ensure the stable operation of the grid.

In some embodiments, a load power and a loss power of the microgrid are obtained based on the analysis results of the real-time data; a usage power of the microgrid is obtained based on the load power and loss power of the microgrid; uncertain factors in the microgrid are obtained, and a safety margin power required for the stable operation of the microgrid is determined based on the uncertain factors; and the operating power required to maintain the stable operation of the microgrid is obtained based on the usage power and the safety margin power.

The usage power may be understood as a power consumed for current stable operation of the microgrid.

The uncertain factors may be those existing in the microgrid, such as power generation fluctuations of distributed power supplies and load prediction errors.

The safety margin power may be a power added to deal with the uncertain factors and ensure that the microgrid can still maintain stable operation in face of sudden situations or faults.

Specifically, as described in the above embodiment, the real-time data includes the load power and the loss power. Therefore, the real-time data is analyzed and extracted by using a data analysis tool to obtain the load power and the loss power. The load power is added to the loss power to obtain the usage power of the microgrid.

Operating data of the microgrid in a historical period is obtained and analyzed to determine the uncertain factors that affect the operation of the microgrid in different scenarios. The uncertain factors at current time, such as fluctuations of wind speed, randomness of load demands, and a possibility of device failure, are determined and analyzed based on the operating scenario of the microgrid at the current time, the safety margin power required for the stable operation of the microgrid is determined through risk assessment and probability analysis, and the usage power is added to the safety margin power to obtain the operating power required to maintain the stable operation of the microgrid.

Through the method provided in this embodiment, the real-time monitoring and analysis on the load power and the loss power can provide a more precise understanding of load conditions that the energy storage devices may encounter. By obtaining and analyzing the uncertain factors in the microgrid and determining the safety margin power required for the stable operation of the microgrid accordingly, an impact caused by uncertainties such as wind power fluctuations can be dealt more effectively. By combining the usage power and the safety margin power to determine the operating power required to maintain the stable operation of the microgrid, optimal utilization of energy is achieved, and energy waste is avoided.

In some embodiments, the operating power required to maintain the stable operation of the microgrid is obtained based on the usage power and the safety margin power, with reference to the following formula (1):

$${P}_{required} = {P}_{load} + {P}_{loss} + {P}_{safety} \qquad ( 1 )$$

where P_{required} represents the operating power required to maintain the stable
operation of the microgrid; P_{load} represents the load power of the microgrid; Pₗₒₛₛ represents the loss power in the microgrid; and P_{safety} represents the safety margin power of the microgrid.

Through the method provided in this embodiment, the formula is designed to precisely compute the total power required to maintain the stable operation of the microgrid. The load power, the loss power, and the safety margin power in the usage power are added to obtain a comprehensive power demand value. This value reflects the total power required by the microgrid during normal operation and in dealing with potential risks and uncertainties.

In some embodiments, determining, based on the uncertain factors, a safety margin power required for the stable operation of the microgrid includes:
determining a corresponding fluctuating power based on the uncertain factors, with reference to the following formula (2):

$$Δ {P}_{gen} = N ( {μ}_{gen} , {σ}_{gen}^{2} ) \qquad ( 2 )$$

where ΔP_{gen} represents the fluctuating power induced by uncertainty; μ_{gen} represents a mean value of load fluctuating powers; σ_{gen} represents a standard deviation of the load fluctuating powers; and N(μ_{gen},σ²_{gen}) represents a standard deviation function;
determining the safety margin power based on the fluctuating power, with reference to the following formula (3):

$${P}_{safety} = Δ {P}_{gen , max} = {μ}_{gen} + {z}_{gen} \cdot {σ}_{gen} \qquad ( 3 )$$

where P_{safety} represents the safety margin power; ΔP_{gen,max} represents a maximum fluctuating power induced by uncertainty; μ_{gen} represents the mean value of the fluctuating powers; z_{gen} represents a corresponding quantile at a confidence level; σ_{gen} represents the standard deviation of the fluctuating powers.

Specifically, the uncertainty of the load fluctuating power ΔP_{gen} is described through a normal distribution, where the mean value μ_{gen} and the standard deviation σ_{gen} reflect an average level and a dispersion degree of load fluctuations respectively. This method can effectively quantify the load fluctuations induced by environmental factors and the like, thereby providing a basis for subsequent computation of the safety margin power. By computing the maximum fluctuating power ΔP_{gen,max} induced by uncertainty, namely, the safety margin power P_{safety}, it can be ensured that the microgrid can still operate stably in face of maximum possible load fluctuations. The safety margin is set based on the confidence level (represented by z_{gen}), and the higher the confidence level, the greater the required safety margin.

Through the method provided in this embodiment, the formula is designed to obtain a reasonable safety margin power, which can help prevent problems such as power supply interruption or device damage in face of uncertainties induced by the access of renewable energy sources such as distributed wind turbines, thereby ensuring stable operation.

In some embodiments, determining a total charging power for energy storage devices based on the operating power and the total generating power refers to the following formula (4):

$${P}_{total} = {\sum }_{i = 1}^{n} {P}_{wind , i} - {P}_{required} \qquad ( 4 )$$

whe; Pₜₒₜₐₗ represents the total charging power; P_{wind,i} represents a generating power of the i^{th} distributed wind turbine; n represents a quantity of the distributed wind turbines in the microgrid; and P_{required} represents the operating power required to maintain the stable operation of the microgrid.
P_{wind,i} may be obtained by statistical analysis on historical wind power generation data.

Specifically, the generating powers P_{wind,i} of the distributed wind turbines are summed up, the sum is subtracted from the operating power P_{required} of the microgrid, and the result is designated as the total power that the energy storage device needs to absorb.

Through the method provided in this embodiment, the formula is designed to obtain the total charging power, ensuring that excess energy can be absorbed by the energy storage devices when the wind generating power exceeds the operating power, thereby avoiding energy waste and device overload.

In some embodiments, the operating status is analyzed to obtain a current electric quantity and a power load of the energy storage device; the distribution status is analyzed to obtain a transmission distance between the energy storage device and the microgrid; a line loss is obtained based on the transmission distance; and
the charging power that should be allocated to each energy storage device is determined based on the current electric quantity and power load, the usage frequency, and the line loss, with reference to the following formula (5):

$${P}_{i} = {P}_{total} \cdot \frac{\frac{{f}_{j} \cdot {s}_{i}}{1 + l ( {d}_{i} )}}{{\sum }_{i = 1}^{n} \frac{{f}_{j} \cdot {s}_{i}}{1 + l ( {d}_{i} )}} \qquad ( 5 )$$

where Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;

The line loss is obtained based on the transmission distance, with reference to the following formula (6):

$$l ( {d}_{i} ) = ( \frac{{P}_{total}}{{d}_{i}^{2}} ) \cdot ( 1 - \frac{{l}_{i}^{2} \cdot ρ \text{?}}{{P}_{total}} ) \cdot {η}_{i} \qquad ( 6 )$$

$$\text{?} \text{indicates text missing or illegible when filed}$$

where l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Δᵢ represents a cross-sectional area of the transmission line for the i^{th} energy storage device; and ηᵢ represents a conversion efficiency of the i^{th} energy storage device;

a maximum energy storage capacity of the energy storage device is obtained based on the current electric quantity, where the power load does not exceed a maximum power limit, with reference to the following formula (7):

$$0 \leq {P}_{i} \leq {P}_{max , i} ∀ i \qquad ( 7 )$$

where Pᵢ represents the charging power for the i^{th} energy storage device; and P_{max,i} represents a maximum charging power for the i^{th} energy storage device.

The power load may be electric energy consumed by a real-time load device of the energy storage device.

The maximum energy storage capacity may be a maximum rechargeable capacity remaining after the current capacity of the energy storage device is deducted.

The maximum power limit is a maximum charging power preset for the energy storage device.

The status function of the current electric quantity and power load of each energy storage device is computed by with reference to the following formula (8):

$${S}_{i} = α ( \frac{current remaining electric quantity i}{total electric quantity i} ) + β ( \frac{power load i}{maximum power load i} ) \qquad ( 8 )$$

where α and β represent weights of the electric quantity and the power load respectively, and α+β=1.

Specifically, current electric quantity and power load data of each energy storage device is analyzed, the status function sᵢ of the current electric quantity and power load of each energy storage device is computed through the formula (8), transmission distance data between the energy storage device and the microgrid is obtained, and the line loss function l(dᵢ) of each energy storage device is computed based on the transmission distance data through the formula (6), where

$$\frac{{P}_{total}}{{d}_{i}^{2}}$$

is defined as an electric power attenuation factor of the transmission distance, representing that the transmitted electric power attenuates with a square of the transmission distance, and reflecting the loss of electric energy during transmission;

$$1 - \frac{{l}_{i}^{2} \cdot ρ \text{?}}{{P}_{total}}$$

$$\text{?} \text{indicates text missing or illegible when filed}$$

is defined as a transmission loss factor, which represents a transmission loss induced by the current, the resistance and cross-sectional area of the transmission line, and the transmission distance, and is used to adjust the actual electric power available for charging; ηᵢ is defined as the conversion efficiency of the energy storage device, representing an efficiency that the energy storage device converts the inputted electric energy into electric energy available for the energy storage device; and the charging power Pᵢ that should be allocated to each energy storage device is computed by using the formula (5) based on the current electric quantity, power load, usage frequency, and line loss of the energy storage device, thereby allocating the charging power reasonably. In practical application, different weights may be assigned for the electric quantity and the power load through the formula (8) based on specific circumstances.

Through the method provided in this embodiment, the current electric quantity and power load of the energy storage device are obtained by monitoring its operating status. Considering the current status, usage frequency, and line loss of each energy storage device, the formula (5) can ensure reasonable allocation of the charging power among the energy storage devices. The charging power is adjusted based on the usage frequency of the energy storage device. A higher usage frequency often means that the energy storage device is closer to the microgrid and has less loss during energy allocation, and that the frequently used energy storage device is preferentially charged and its line loss during usage is reduced. Such adjustment can also avoid insufficient charging for other energy storage devices due to overload of some energy storage devices. By optimizing the allocation of the charging power, unnecessary energy loss is reduced, and the overall charging efficiency of the energy storage devices is improved. To effectively store and utilize the electric energy generated by the distributed wind turbines, by considering the line loss and the usage frequency, the computation of formula (5) can prevent damage to the energy storage device due to excessive charging load; the line loss can provide data support for evaluating the charging efficiency and cost of the energy storage device; by computing the line loss, a more economical charging solution is selected; when energy storage devices are selected, the consideration of the transmission distance can reduce unnecessary energy loss and improve energy storage efficiency; when the distributed wind turbines access the microgrid and generate fluctuating electric energy, the selection of more economical energy storage devices can reduce loads on the energy storage devices, prolong their service lives, and lower the risk of damage; in cases of scarce energy storage, energy storage devices with less remaining power are given priority as options; however, when the microgrid can maintain stable operation, the power load may be even more crucial; the computation of the total charging power ensures the operation of devices within a safe range, prevents overloading of the devices, prolongs the service lives of the devices, reduces the risk of failure, and avoids overcharging, thereby maintaining the healthy status of the energy storage devices and prolonging their service life, and ensuring that the power load of each energy storage device does not exceed its maximum power limit.

In some embodiments, load balancing is performed based on the power load of each energy storage device, with reference to the following formula (9):

$${L}_{i} = \frac{{P}_{i}}{{P}_{max , i}} \qquad ( 9 )$$

where Lᵢ represents an i^{th} load factor; Pᵢ represents the charging power for the i^{th} energy storage device; and P_{max,i} represents the maximum charging power for the i^{th} energy storage device;
the load factor Lᵢ is an indicator used to quantify a ratio of the current charging power for each energy storage device to the maximum charging power therefor; a final load factor during the load balancing is obtained based on the load factors of all the energy storage devices; and the charging power for each energy storage device during the load balancing is obtained based on the final load factor.

The maximum charging power may be found in the specification or technical manual of the device and is preset in the server.

Specifically, the load factor Lᵢ of each energy storage device is computed by using the formula (8). The load factor is a value between 0 and 1, representing the ratio of the current charging power to the maximum charging power. Based on the load factors of all the energy storage devices, the overall load distribution can be more uniform to prevent some devices from being overloaded while others are idle. Based on the load factors of all the energy storage devices, load balancing adjustments can be made to ensure that the load factor of each device is as close as possible, thereby achieving balanced allocation of power.

Through the method provided in this embodiment, the load balancing can ensure that each energy storage device is effectively utilized, thereby improving the charging efficiency of an overall system, avoiding accelerated aging or damage of some devices due to overload, and thus prolonging the service lives of the energy storage devices. When all the energy storage devices operate at a similar load level, the overall stability of the system will be enhanced. The load balancing facilitates more reasonable allocation of the charging power among the energy storage devices, thereby ensuring efficient utilization of energy.

In some embodiments, the load factor during the load balancing is obtained based on the load factors of all the energy storage devices, with reference to the following formula (10):

$$L = min {\sum }_{i = 1}^{n} {( {L}_{i} - \overline{L} )}^{2} \qquad ( 10 )$$

where L represents the final load factor during the load balancing; Lᵢ represents the load factor of the i^{th} energy storage device; and L̅ represents a mean value of the load factors of all the energy storage devices;

A specific computation method is as follows: Lᵢ and corresponding Pᵢ are initialized; current L̅ is computed; an objective function L is computed until Lᵢ is satisfied (where i is from 1 to n), so that a sum of squares of the difference between each Lᵢ and the mean value L̅ is minimized; and the Lᵢ satisfying L is designated as the final load factor during the load balancing.

Lᵢ may be set based on the previous operating data of the energy storage device, the specification of the energy storage device, or a preset safety value.

Pᵢ may be set based on the previous operating data of the energy storage device, the specification of the energy storage device, or a preset safety value.

Specifically, during computation, Lᵢ or corresponding Pᵢ needs to be initialized, then current L̅ is computed, adjustments are made according to the formula (9) (i.e., a sum of squares of differences between all Lᵢ and the mean value L̅) until a power allocation scheme minimizing L is found, and Lᵢ corresponding to L is the final load factor during the load balancing.

Through the method provided in this embodiment, the charging power for each energy storage device is adjusted to make their load factors as close as possible, thereby avoiding the situation where some energy storage devices are overloaded while others are lightly loaded. When all the devices operate at a similar load level, the charging efficiency of the overall system is improved, the energy storage devices operate in an inefficient status to avoid overload, the service lives of the energy storage devices can be effectively prolonged, and damage to the energy storage devices can be avoided, thereby improving the stability of the overall system.

In some embodiments, keywords are extracted from historical power generation data in the microgrid to obtain simple data; the simple data is cleaned to obtain cleaned data; the cleaned data is normalized to obtain computable data; a model associated between the generating power and meteorological factors is trained based on the computable data; and real-time meteorological data is inputted into the trained model to obtain the total generating power within the preset time.

The simple data may include the number, capacity, generating power, and timestamp of the wind turbines, weather data, etc.

The computable data may be valid data obtained after the simple data is cleaned and normalized, and may be used for model training.

The model associated between the generating power and meteorological factors may be a linear regression model.

Specifically, key information such as power generation time, generating power, temperature, humidity, and wind speed is extracted from the historical power generation data of the microgrid, and the data is cleaned and normalized for model training. The cleaned and normalized data is used to train a linear regression model for machine learning. The linear regression model learns a group of optimal parameters, which are used to establish a relationship between input features (meteorological factors) and a target variable (generating power). The historical power generation data and the meteorological data are generally collected by sensors and stored in a database.

Through the method provided in this embodiment, by training the linear regression model to learn historical data, the linear regression model learns how to predict a generating power based on these meteorological factors, thereby more accurately predicting a future generating power. Accurate predictions can formulate and adjust the charging allocation strategy for the energy storage devices. Through prediction, unnecessary investment in backup power supplies can be reduced, and operating costs can be lowered.

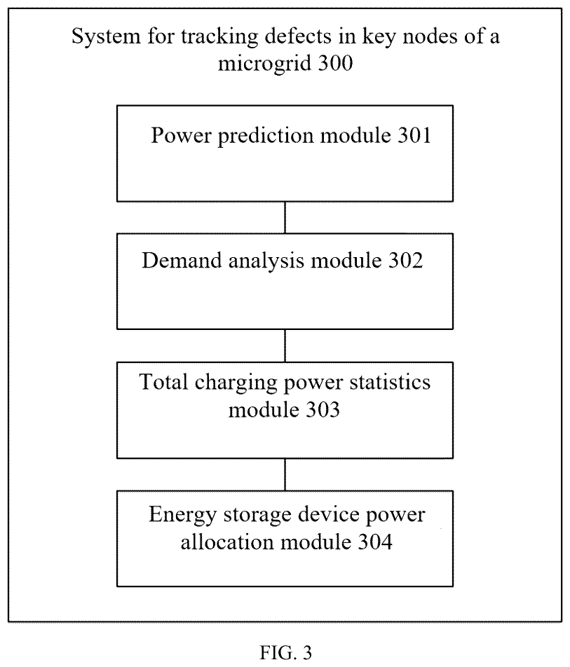

FIG. 3 is a schematic structural diagram of a system for tracking defects in key nodes of a microgrid according to an embodiment of the present application. As shown in FIG. 3, the system for tracking defects in key nodes of a microgrid 300 in this embodiment includes: a power prediction module 301, a demand analysis module 302, a total charging power statistics module 303, and an energy storage device power allocation module 304.

The power prediction module 301 is configured to obtain real-time data of the microgrid, analyze the real-time data to obtain power generation data of each distributed wind turbine in the microgrid, and analyze the power generation data to predict a total generating power within a preset time;

The demand analysis module 302 is configured to obtain an operating power required for stable operation of the microgrid based on the real-time data;

The total charging power statistics module 303 is configured to determine a total charging power for energy storage devices based on the operating power and the total generating power; and

The energy storage device power allocation module 304 is configured to obtain an operating status, a usage frequency, and a distribution status of each energy storage device, and determine a charging power that should be allocated to each energy storage device based on the total charging power, the operating status, the usage frequency, and the distribution status; and designate the charging power that should be allocated to each energy storage device as a charging allocation strategy.

Optionally, the demand analysis module 302 is specifically configured to:
obtain a load power and a loss power of the microgrid based on the analysis results of the real-time data;
obtain a usage power of the microgrid based on the load power and the loss power of the microgrid;
obtain uncertainty factors in the microgrid, and determine a safety margin power required for the stable operation of the microgrid based on the uncertainty factors; and
obtain the operating power required to maintain the stable operation of the microgrid based on the usage power and the safety margin power.

Optionally, the demand analysis module 302 is specifically configured to:
obtain the operating power required to maintain the stable operation of the microgrid based on the usage power and the safety margin power, with reference to the following formula:

$${P}_{required} = {P}_{laod} + {P}_{loss} + {P}_{safety} ;$$

where P_{required} represents the operating power required to maintain the stable operation of the microgrid; P_{load} represents the load power of the microgrid; Pₗₒₛₛ represents the loss power in the microgrid; and P_{safety} represents the safety margin power of the microgrid.

Optionally, the demand analysis module 302 is specifically configured to:
determine the safety margin power required for the stable operation of the microgrid based on the uncertainty factors, including:
determining a corresponding fluctuating power based on the uncertainty factors, with reference to the following formula:

$$Δ {P}_{gen} = N ( {μ}_{gen} , {σ}_{gen}^{2} ) ;$$

where ΔP_{gen} represents the fluctuating power induced by uncertainty; μ_{gen} represents a mean value of load fluctuating powers; σ_{gen} represents a standard deviation of the load fluctuating powers; and N(μ_{gen},σ²_{gen}), represents a standard deviation function;
determining the safety margin power based on the fluctuating power, with reference to the following formula:

$${P}_{safety} = Δ {P}_{gen , max} = {μ}_{gen} + {z}_{gen} \cdot {σ}_{gen} ;$$

where P_{safety} represents the safety margin power; ΔP_{gen,max} represents a maximum fluctuating power induced by uncertainty; μ_{gen} represents the mean value of the fluctuating powers; z_{gen} represents a corresponding quantile at a confidence level; and σ_{gen} represents the standard deviation of the fluctuating powers.

Optionally, the total charging power statistics module 303 is specifically configured to:
determine the total charging power for the energy storage devices based on the operating power and the total generating power, with reference to the following formula:

$${P}_{total} = {\sum }_{i = 1}^{n} {P}_{wind , i} - {P}_{required} ;$$

where Pₜₒₜₐₗ represents the total charging power; P_{wind,i} represents a generating power of the i^{th} distributed wind turbine; n represents a quantity of the distributed wind turbines in the microgrid; and P_{required} represents the operating power required to maintain the stable operation of the microgrid.

Optionally, the total charging power statistics module 303 is specifically configured to:
analyze the operating status to obtain a current electric quantity and power load of the energy storage device;
analyze the distribution status to obtain a transmission distance between the energy storage device and the microgrid;
obtain a line loss based on the transmission distance; and
determine the charging power that should be allocated to each energy storage device based on the current electric quantity and power load, the usage frequency, and the line loss, with reference to the following formula:

$${P}_{i} = {P}_{total} \cdot \frac{\frac{\text{?}}{1 + l ( {d}_{i} )}}{{\sum }_{j = 1}^{n} \frac{\text{?}}{1 + l ( {d}_{j} )}} ;$$

$$\text{?} \text{indicates text missing or illegible when filed}$$

where Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;
obtain the line loss based on the transmission distance, with reference to the following formula:

$$l ( {d}_{i} ) = ( \frac{{P}_{total}}{{d}_{i}^{2}} ) \cdot ( 1 - \frac{{l}_{i}^{2} \cdot ρ \text{?}}{{P}_{total}} ) \cdot {η}_{i} ;$$

$$\text{?} \text{indicates text missing or illegible when filed}$$

where l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Aᵢ represents a cross-sectional area of the transmission line for the i^{th} energy storage device; and ηᵢ represents a conversion efficiency of the i^{th} energy storage device;
obtain a maximum energy storage capacity of the energy storage device based on the current electric quantity;
where the power load does not exceed a maximum power limit, with reference to the following formula:

$$0 \leq {P}_{i} \leq {P}_{max , i} , ∀ i ;$$

where Pᵢ represents the charging power for the i^{th} energy storage device; and P_{max,i} represents a maximum charging power for the i^{th} energy storage device.

Optionally, the energy storage device power allocation module 304 is specifically configured to:
perform load balancing based on the power load of each energy storage device,
with reference to the following formula:

$${L}_{i} = \frac{{P}_{i}}{{P}_{max , i}} ;$$

where Lᵢ represents an i^{th} load factor; Pᵢ represents the charging power for the i^{th} energy storage device; and P_{max,i} represents the maximum charging power for the i^{th} energy storage device;
where the load factor Lᵢ is an indicator used to quantify a ratio of the current charging power for each energy storage device to the maximum charging power therefor;
obtain a load factor during the load balancing based on the load factors of all the energy storage devices; and
obtain the charging power for each energy storage device during the load balancing based on the load factor.

Optionally, the energy storage device power allocation module 304 is specifically configured to:
obtain the load factor during the load balancing based on the load factors of all the energy storage devices, with reference to the following formula:

$$L = min {\sum }_{i = 1}^{n} {( {L}_{i} - \overline{L} )}^{2} ;$$

where L represents the final load factor during the load balancing; Lᵢ represents the load factor of the i^{th} energy storage device; and L̅ represents a mean value of the load factors of all the energy storage devices.

Optionally, the feature extraction module 301 is specifically configured to:
extract keywords from historical power generation data in the microgrid to obtain simple data;
clean the simple data to obtain cleaned data;
normalize the cleaned data to obtain computable data;
train a model associated between the generating power and meteorological factors based on the computable data; and
input real-time meteorological data into the trained model to obtain the total generating power within the preset time.

The system of this embodiment can be configured to implement the method in any of the above embodiments. Their implementation principles and technical effects are similar and will not be elaborated here.

What is claimed is:

1. A method for tracking defects in key nodes of a microgrid, comprising:
obtaining real-time data of the microgrid, analyzing the real-time data to obtain power generation data of each distributed wind turbine in the microgrid, and analyzing the power generation data to predict a total generating power within a preset time;
obtaining an operating power required for stable operation of the microgrid based on analysis results of the real-time data;
determining a total charging power for energy storage devices based on the operating power and the total generating power; and
obtaining an operating status, a usage frequency, and a distribution status of each energy storage device, and determining a charging power that should be allocated to each energy storage device based on the total charging power, the operating status, the usage frequency, and the distribution status; and designating the charging power that should be allocated to each energy storage device as a charging allocation strategy;
wherein determining a charging power that should be allocated to each energy storage device based on the total charging power, the operating status, the usage frequency, and the distribution status comprises:
analyzing the operating status to obtain a current electric quantity and power load of the energy storage device;
analyzing the distribution status to obtain a transmission distance between the energy storage device and the microgrid;
obtaining a line loss based on the transmission distance; and
determining the charging power that should be allocated to each energy storage device based on the current electric quantity and power load, the usage frequency, and the line loss, with reference to the following formula:
$${P}_{i} = {P}_{total} \cdot \frac{\frac{{f}_{i} \cdot {s}_{i}}{1 + l ( {d}_{i} )}}{{\sum }_{j = 1}^{n} \frac{{f}_{j} \cdot {s}_{j}}{1 + l ( {d}_{j} )}} ;$$
wherein Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;
wherein obtaining a line loss based on the transmission distance refers to the following formula:
$$l ( {d}_{i} ) = ( \frac{{P}_{total}}{{d}_{i}^{2}} ) \cdot ( 1 - \frac{{I}_{i}^{2} \cdot {ρ}_{i} \cdot \frac{{d}_{i}}{{A}_{i}}}{{P}_{total}} ) \cdot {η}_{i} ;$$
wherein l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Aᵢ represents a cross-sectional area of the transmission line for the i^{th} energy storage device; and ηᵢ represents a conversion efficiency of the i^{th} energy storage device;
obtaining a maximum energy storage capacity of the energy storage device based on the current electric quantity;
wherein the power load does not exceed a maximum power limit, with reference to the following formula:
$$0 \leq {P}_{i} \leq {P}_{max , i} , ∀ i ;$$
wherein Pᵢ represents the charging power for the i^{th} energy storage device; and P_{max,i} represents a maximum charging power for the i^{th} energy storage device.

2. The method according to claim 1, wherein obtaining an operating power required for stable operation of the microgrid based on the real-time data comprises:
obtaining a load power and a loss power of the microgrid based on the analysis results of the real-time data;
obtaining a usage power of the microgrid based on the load power and the loss power of the microgrid;
obtaining uncertainty factors in the microgrid, and determining a safety margin power required for the stable operation of the microgrid based on the uncertainty factors; and
obtaining the operating power required to maintain the stable operation of the microgrid based on the usage power and the safety margin power.

3. The method according to claim 2, wherein obtaining the operating power required to maintain the stable operation of the microgrid based on the usage power and the safety margin power refers to the following formula:
$${P}_{required} = {P}_{load} + {P}_{loss} + {P}_{safety} ;$$
wherein P_{required} represents the operating power required to maintain the stable operation of the microgrid; P_{load} represents the load power of the microgrid; Pₗₒₛₛ represents the loss power in the microgrid; and P_{safety} represents the safety margin power of the microgrid.

4. The method according to claim 3, wherein determining a safety margin power required for the stable operation of the microgrid based on the uncertainty factors comprises:
determining a corresponding fluctuating power based on the uncertainty factors, with reference to the following formula:
$$Δ {P}_{gen} = N ( {μ}_{gen} , {σ}_{gen}^{2} ) ;$$
wherein ΔP_{gen} represents the fluctuating power induced by uncertainty; μ_{gen} represents a mean value of load fluctuating powers; σ_{gen} represents a standard deviation of the load fluctuating powers; and N(μ_{gen},σ²_{gen}) represents a standard deviation function;
determining the safety margin power based on the fluctuating power, with reference to the following formula:
$${P}_{safety} = Δ {P}_{gen , max} = {μ}_{gen} + {z}_{gen} \cdot {σ}_{gen} ;$$
wherein P_{safety} represents the safety margin power; ΔP_{gen,max} represents a maximum fluctuating power induced by uncertainty; μ_{gen} represents the mean value of the fluctuating powers; z_{gen} represents a corresponding quantile at a confidence level; and σ_{gen} represents the standard deviation of the fluctuating powers.

5. The method according to claim 3, wherein determining a total charging power for energy storage devices based on the operating power and the total generating power refers to the following formula:
$${P}_{total} = {\sum }_{i = 1}^{n} {P}_{wind , i} - {P}_{required} ;$$
wherein Pₜₒₜₐₗ represents the total charging power; P_{wind,i} represents a generating power of the i^{th} distributed wind turbine; n represents a quantity of the distributed wind turbines in the microgrid; and P_{required} represents the operating power required to maintain the stable operation of the microgrid.

6. The method according to claim 1, wherein determining a charging power that should be allocated to each energy storage device based on the total charging power, the operating status, the usage frequency, and the distribution status further comprises:
performing load balancing based on the power load of each energy storage device, with reference to the following formula:
$${L}_{i} = \frac{{P}_{i}}{{P}_{max , i}} ;$$
wherein Lᵢ represents an i^{th} load factor; Pᵢ represents the charging power for the i^{th} energy storage device; and P_{max,i} represents the maximum charging power for the i^{th} energy storage device;
wherein the load factor Lᵢ is an indicator used to quantify a ratio of the current charging power for each energy storage device to the maximum charging power therefor;
obtaining a final load factor during the load balancing based on the load factors of all the energy storage devices; and
obtaining the charging power for each energy storage device during the load balancing based on the final load factor.

7. The method according to claim 6, wherein obtaining a final load factor during the load balancing based on the load factors of all the energy storage devices refers to the following formula:
$$L = min {\sum }_{i = 1}^{n} {( {L}_{i} - \overline{L} )}^{2} ;$$
wherein L represents the final load factor during the load balancing; Lᵢ represents the load factor of the i^{th} energy storage device; and L̅ represents a mean value of the load factors of all the energy storage devices; and
designating the Lᵢ satisfying L as the final load factor during the load balancing.

8. The method according to claim 5, wherein analyzing the power generation data to predict a total generating power within a preset time comprises:
extracting keywords from historical power generation data in the microgrid to obtain simple data;
cleaning the simple data to obtain cleaned data;
normalizing the cleaned data to obtain computable data;
training a model associated between the generating power and meteorological factors based on the computable data; and
inputting real-time meteorological data into the trained model to obtain the total generating power within the preset time.

9. A system for tracking defects in key nodes of a microgrid, comprising:
a power prediction module, configured to obtain real-time data of the microgrid, analyze the real-time data to obtain power generation data of each distributed wind turbine in the microgrid, and analyze the power generation data to predict a total generating power within a preset time;
a demand analysis module, configured to obtain an operating power required for stable operation of the microgrid based on the real-time data;
a total charging power statistics module, configured to determine a total charging power for energy storage devices based on the operating power and the total generating power; and
an energy storage device power allocation module, configured to obtain an operating status, a usage frequency, and a distribution status of each energy storage device, and determine a charging power that should be allocated to each energy storage device based on the total charging power, the operating status, the usage frequency, and the distribution status; and designate the charging power that should be allocated to each energy storage device as a charging allocation strategy;
wherein the total charging power statistics module is specifically configured to:
analyze the operating status to obtain a current electric quantity and power load of the energy storage device;
analyze the distribution status to obtain a transmission distance between the energy storage device and the microgrid;
obtain a line loss based on the transmission distance; and
determine the charging power that should be allocated to each energy storage device based on the current electric quantity and power load, the usage frequency, and the line loss, with reference to the following formula:
$${P}_{i} = {P}_{total} \cdot \frac{\frac{{f}_{i} \cdot {s}_{i}}{1 + l ( {d}_{i} )}}{{\sum }_{j = 1}^{n} \frac{{f}_{j} \cdot {s}_{j}}{1 + l ( {d}_{j} )}} ;$$
wherein Pᵢ represents the charging power allocated to the i^{th} energy storage device; Pₜₒₜₐₗ represents the total charging power; fᵢ represents the usage frequency of the i^{th} energy storage device; sᵢ represents a status function of the current electric quantity and power load of the i^{th} energy storage device; l(dᵢ) represents a line loss function of the i^{th} energy storage device; fⱼ represents the usage frequency of the j^{th} energy storage device; sⱼ represents a status function of the current electric quantity and power load of the j^{th} energy storage device; l(dⱼ) represents a line loss function of the j^{th} energy storage device; and n represents a total number of the energy storage devices;
wherein obtaining a line loss based on the transmission distance refers to the following formula:
$$l ( {d}_{i} ) = ( \frac{{P}_{total}}{{d}_{l}^{2}} ) \cdot ( 1 - \frac{{I}_{i}^{2} \cdot {ρ}_{i} \cdot \frac{{d}_{i}}{{A}_{i}}}{{P}_{total}} ) \cdot {η}_{i} ;$$
wherein l(dᵢ) represents the line loss function of the i^{th} energy storage device; Pₜₒₜₐₗ represents the total charging power; dᵢ represents the transmission distance between the i^{th} energy storage device and the microgrid; Iᵢ represents a transmission current in the i^{th} energy storage device; ρᵢ represents a resistivity of a transmission line used for the i^{th} energy storage device; Aᵢ represents a cross-sectional area of the transmission line for the i^{th} energy storage device; and ηᵢ represents a conversion efficiency of the i^{th} energy storage device;
wherein the power load does not exceed a maximum power limit, with reference to the following formula:
$$0 \leq {P}_{i} \leq {P}_{max , i} , ∀ i ;$$
wherein Pᵢ represents the charging power for the i^{th} energy storage device; and P_{max,i} represents a maximum charging power for the i^{th} energy storage device.
